(19) United States
(12) Patent Application Publication
(10) Pub. No.: US 2011/0218729 A1
(43) Pub. Date: Sep. 8, 2011

(54) ENGINE START CONTROL SYSTEM

(75) Inventor: Ryohei TAKAHASHI, Kariya-city (JP)

(73) Assignee: DENSO CORPORATION, Kariya-city (JP)

(21) Appl. No.: 13/037,607

(22) Filed: Mar. 1, 2011

(30) Foreign Application Priority Data
Mar. 2, 2010 (JP) 2010-45996

(51) Int. Cl. F02N 11/08

(52) U.S. Cl. 701/113

(57) ABSTRACT

When a CPU for controlling an operation of a starter motor is reset due to a decrease of a power supply voltage during the operation of the starter motor, the CPU neglects a satisfaction of a starter stop condition for a predetermined period from a return of the CPU. The CPU changes the predetermined period for neglecting the starter stop condition, based on at least one of parameters, such as, the power supply voltage, an ambient temperature, a number of resets of the CPU during one cranking operation, and so on.

### CROSS REFERENCE TO RELATED APPLICATION

This application is based on Japanese Patent Application No. 2010-045996 filed on Mar. 2, 2010, the disclosure of which is incorporated herein by reference.

### FIELD OF THE INVENTION

The present invention relates to an engine start control system, according to which ON-OFF operation of a starter motor for starting an engine is controlled by CPU.

### BACKGROUND OF THE INVENTION

According to one of known prior arts, for example, as disclosed in Japanese Patent Publication No. 2008-291763, a starter switch of a push-button type is provided in place of an ignition switch of a rotational operation type, wherein a signal of pushing operation for the push-button type switch is inputted to CPU, and a command signal for turning on a starter motor is outputted from the CPU in order to crank up an engine of a vehicle.

According to such a prior art, an operation of the starter motor is terminated when a condition for stopping the operation of the starter motor (hereinafter also referred to as “a starter stop condition”) is satisfied during the operation of the starter motor. In addition, the operation of the starter motor is prohibited when the starter stop condition is satisfied during the starter motor is not in its operation.

The starter stop condition is determined, for example, by the following determinations;
a determination for completion of cranking up the engine (determination whether an engine rotational speed exceeds a predetermined value for cranking up the engine);
a determination for engine cranking operation of a long time period (determination whether the engine cranking operation exceeds a allowable maximum cranking time, in view of protecting a battery from a long cranking operation);
a determination of a vehicle speed (determination whether the vehicle speed exceeds a predetermined value);
a determination of a shift-lever position (determination whether the shift-lever is not positioned at a “P” range or a “N” range)
a determination of fuel leakage (determination whether a fuel leakage occurs);
a determination of an immobilizer (determination whether an ID code is verified between a key of a driver and an ECU of a vehicle);
a determination of fuel pressure (determination whether fuel pressure necessary for starting the engine is achieved), and so on.

Since a large amount of electric current flows from the battery to the starter motor during the operation thereof, battery voltage is inevitably and temporarily decreased. The electric power is also supplied from the battery to the CPU, which controls the ON-OFF operation of the starter motor. Therefore, in a case that a charged amount in the battery is decreased, the CPU may be reset if power supply voltage to the CPU is decreased to become lower than a voltage of a proper operation for the CPU during the operation of the starter motor.

When the power supply voltage to the CPU is decreased to be lower than the voltage of the proper operation for the CPU during the operation of the starter motor, and thereby the CPU is reset, it may become uncertain whether the starter stop condition is satisfied or not. As a result, the operation of the starter motor may be stopped and thereby the engine may not be properly cranked up.

In order to solve such a problem, according to the above prior art (JP 2008-291763), another CPU (Power supply ECU) is provided in addition to the CPU (Engine ECU) for controlling the operation of the starter motor, wherein the voltage of the proper operation for the CPU (Power supply ECU) is set at a value lower than that for the CPU (Engine ECU). In the case that the CPU (Engine ECU) is reset during the operation of the starter motor, a starter relay is kept in an ON-condition for a certain period by the CPU (Power supply ECU), the voltage of the proper operation for which is lower than that for the CPU (Engine ECU). Accordingly, the engine is cranked up.

According to the above structure, however, it is necessary for two CPUs to work together in their control processes for controlling the operation of the starter motor (ON-OFF control of the starter motor). It is, therefore, a problem that the control processes may become complicated.

### SUMMARY OF THE INVENTION

The present invention is made in view of the above problems. It is an object of the present invention to provide an engine start control system, according to which an ON-condition for a starter motor can be maintained by a simple control process without using an additional CPU, when a CPU for controlling an operation of the starter motor is reset during the operation of the starter motor. As result, an engine can be surely cranked up. Therefore, a problem that the engine may not be cranked up in case of the reset of the CPU can be improved in a low cost.

According to a feature of the present invention, for example, as defined in the appended claim 1, an engine start control system has a CPU for controlling ON-OFF operation of a starter motor to crank up an engine, wherein the CPU stops an operation of the starter motor when a starter stop condition is satisfied during the operation of the starter motor, while the CPU prohibits the operation of the starter motor when the starter stop condition is satisfied during non-operation of the starter motor. In addition, when the CPU is reset during the operation of the starter motor, the CPU neglects satisfaction of the starter stop condition during a predetermined neglecting period from a return of the CPU.

According to such a feature, since the starter stop condition is neglected during the predetermined period from the return of the CPU from its reset condition, it becomes possible to prevent the operation of the starter motor from being stopped when the starter stop condition is satisfied, even in the case that the CPU is reset during the operation of the starter motor. Therefore, it is possible to continue the engine cranking operation to thereby surely start up the engine. As a result, it is possible to start up the engine with a simple control process, even when the CPU is reset during the operation of the starter motor. And the problem that the engine may not be cranked up in case of the reset of the CPU can be improved in a low cost.

The above predetermined neglecting period, during which the satisfaction of the starter stop condition after the return of the CPU is neglected, may be a fixed value. However, according to another feature of the invention, for example, as defined in the appended claim 2, the CPU changes the neglecting period, during which the satisfaction of the starter stop condition is neglected, depending on at least one of the following parameters;
a power supply voltage;
an ambient temperature;
a temperature of engine lubricating oil;
a temperature of engine cooling water;
a number of resets of the CPU during one cranking operation;
an engine rotational speed; and
a communication establishing time for an in-vehicle communication network.

For example, when the voltage of the power supply (the battery voltage) becomes lower, the CPU becomes more likely to be reset. Therefore, it may be better to make longer the neglecting time period for the starter stop condition, as the power supply voltage becomes lower. When the ambient temperature or the engine temperature (such as, the temperature of the lubricating oil, the engine cooling water) becomes lower, a period of the engine cranking operation may become longer. Therefore, it may be better to make longer the neglecting time period for the starter stop condition, as the ambient temperature or the engine temperature becomes lower. When the CPU is repeatedly reset during one engine cranking operation, the time for cranking the engine may become longer and thereby a load to the battery may become larger. Therefore, it may be better to restrict the neglecting time period for the starter stop condition, depending on the number of resets of the CPU during one engine cranking operation. When the engine rotational speed becomes higher, the time period to a timing point for stopping the starter motor (to the completion of engine crank-up) may become shorter. Therefore, it may be better to make shorter the neglecting time period for the starter stop condition, as the engine rotational speed becomes higher. When the time for establishing the communication for the in-vehicle communication network becomes longer, a time period during which a signal for allowing the engine cranking operation is transmitted from the other CPU (ECU) to the CPU for controlling the operation of the starter motor may become longer. Therefore, it may be better to make longer the neglecting time period for the starter stop condition, as the time for establishing the communication becomes longer.

According to a further feature of the invention, for example, as defined in the appended claim 3, the CPU and/or another CPU different from the CPU determines whether the starter stop condition is satisfied based on at least one of the following determinations;
a determination for an engine cranking operation of a long time period;
a determination of a vehicle speed;
a determination whether the engine cranking operation has been completed;
a determination of a shift-lever position;
a determination of fuel leakage;
a determination of an immobilizer;
a determination of fuel pressure; and
a determination of a malfunction of the starter motor.

In case of the above determination for the engine cranking operation of the long time period, the starter stop condition is regarded as being satisfied when a starter-ON time for the operation of the starter motor exceeds an allowable maximum cranking time, which is defined in view of protecting the battery.

In case of the determination of the vehicle speed, the starter stop condition may be regarded as being satisfied when the vehicle speed exceeds a predetermined value.

In case of the determination whether the engine cranking operation has been completed, the starter stop condition may be regarded as being satisfied when the vehicle speed exceeds a predetermined value, which corresponds to a threshold value for determining whether the engine has been started.

In case of the determination of the shift-lever position, the starter stop condition may be regarded as being satisfied when the shift-lever is not positioned at a “P” range or an “N” range.

In case of the determination of the fuel leakage, the starter stop condition may be regarded as being satisfied when a fuel leakage is detected.

In case of the determination of the immobilizer, the starter stop condition may be regarded as being satisfied when verification between a key of a vehicle driver and an ECU for the immobilizer is not completed.

In case of the determination of the fuel pressure, the starter stop condition may be regarded as being satisfied when fuel pressure necessary for starting the engine is not achieved.

In case of the determination of the malfunction of the starter motor, the starter stop condition may be regarded as being satisfied when any malfunction of the starter motor is detected by a starter malfunction diagnosing function, which is mounted in the vehicle.

According to a still further feature, for example, as defined in claim 4, when the CPU is reset during the operation of the starter motor, the CPU is initialized to a side in which the starter stop condition is not satisfied at a return of the CPU, and such an initialized condition is maintained for a predetermined period from the return of the CPU.

According to such a feature, it is also possible to prevent the operation of the starter motor from being stopped even when the CPU is reset during the operation of the starter motor. Therefore, it is possible to continue the engine cranking operation to thereby surely start up the engine. As a result, it is possible to start up the engine with a simple control process, even when the CPU is reset during the operation of the starter motor. And the problem that the engine may not be cranked up in case of the reset of the CPU can be improved in a low cost.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram schematically showing an entire structure for an engine start control system for a vehicle according to a first embodiment of the present invention;

FIGS. 2A and 2B are time charts for explaining a process when CPU is reset during an operation of a starter motor in the first embodiment;

FIG. 3 is a flowchart showing a process at a return of CPU from a reset condition in the first embodiment;

FIG. 4 is a time chart for explaining a process when CPU is reset during an operation of a starter motor according to a second embodiment; and

FIG. 5 is a flowchart showing a process at a return of CPU from a reset condition in the second embodiment.

### DETAILED DESCRIPTION OF THE PREFERRED EMBODIMENTS

Two embodiments of the present invention will be explained.

### First Embodiment

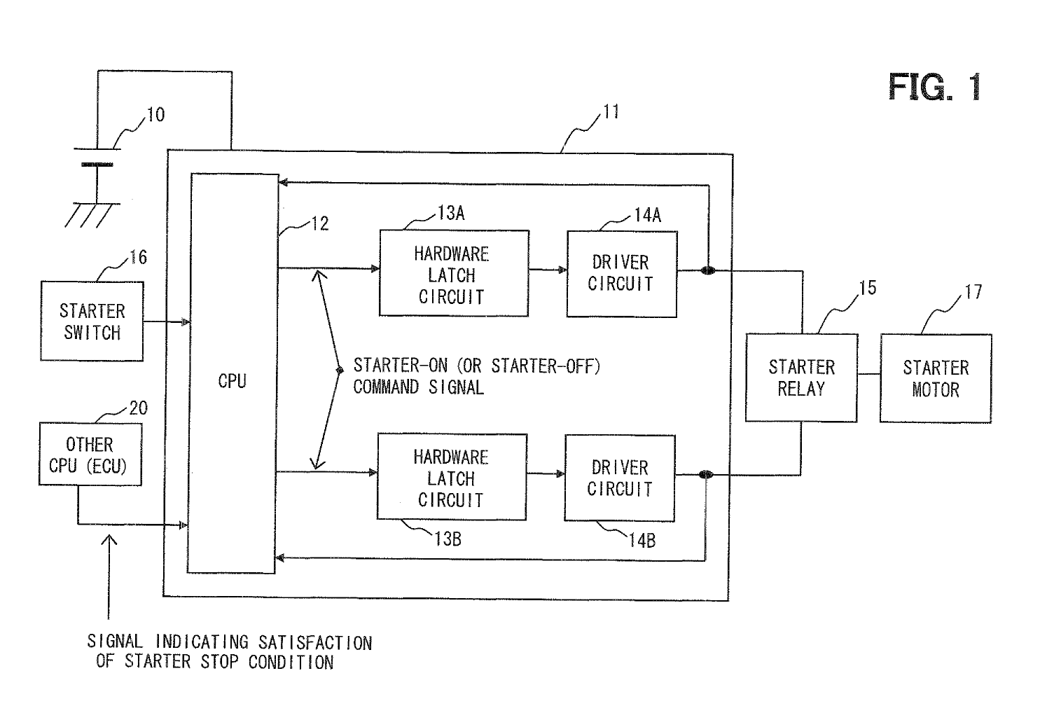

A first embodiment of the present invention will be explained with reference to FIGS. 1 to 3.

At first, a structure of an engine start control system will be explained with reference to FIG. 1.

The engine start control system is composed of an electronic control unit (ECU) 11, to which electric power voltage is supplied from a battery 10 mounted in a vehicle. The ECU 11 is composed of CPU 12, ROM (not shown), RAM (not shown), hardware latch circuits (holding circuits) 13A and 13B, and driver circuits 14A and 14B for driving a starter relay 15. When the starter relay 15 is turned on, electric power is supplied to a starter motor 17 (a starter-ON condition), so that an engine of the vehicle is cranked up. When the starter relay 15 is turned off, the electric power supply to the starter motor 17 is stopped (a starter-OFF condition). A start-up signal is inputted to the CPU 12 from a starter switch 16 of a push-button type when it is operated.

According to the present embodiment, two systems for operating the starter relay 15, namely two hardware latch circuits 13A and 13B and two driver circuits 14A and 14B, are provided.

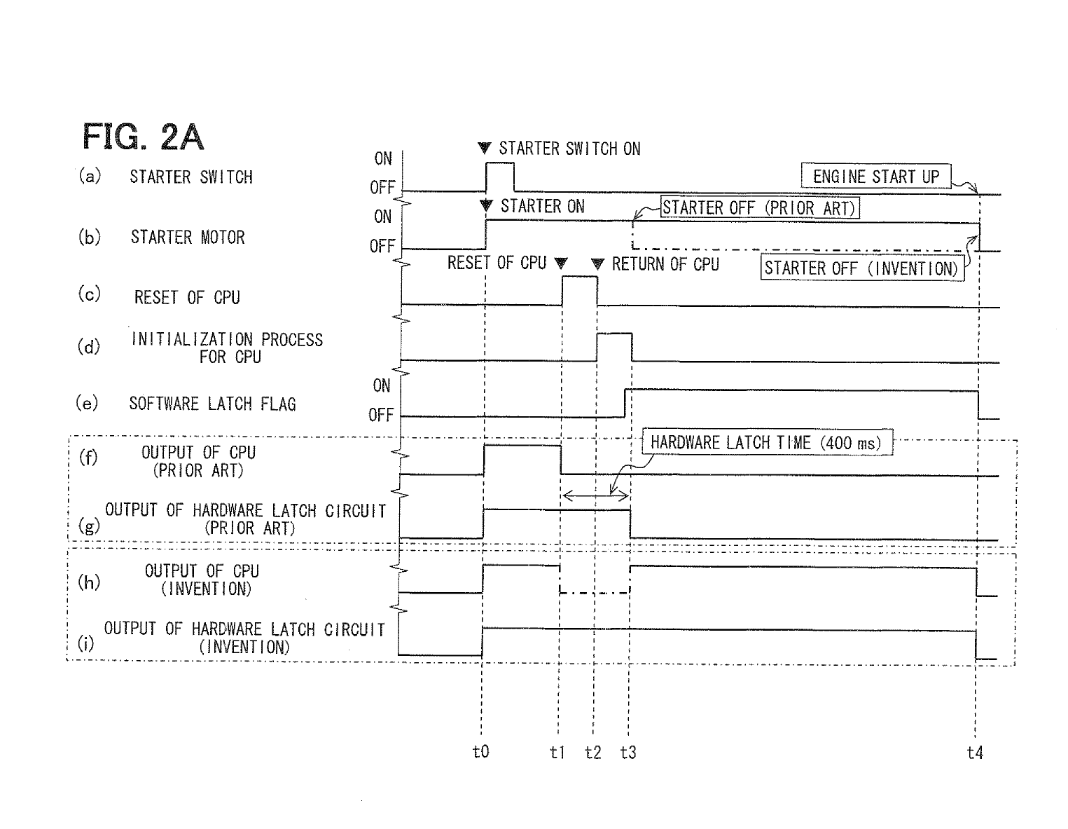

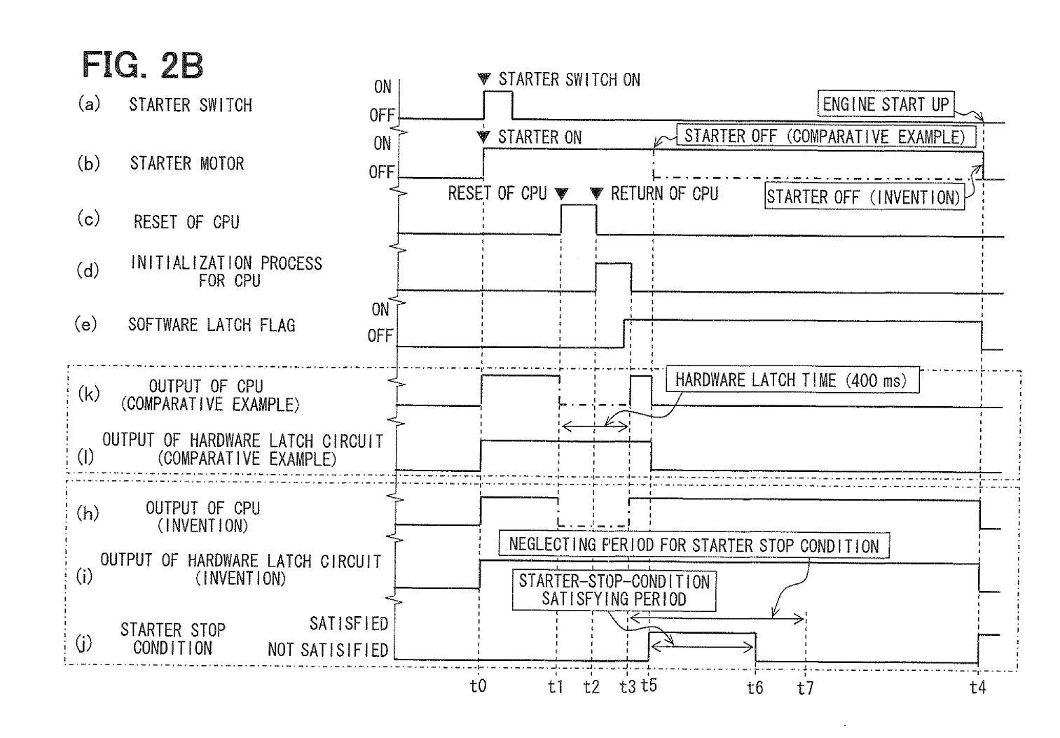

An operation of the engine start control system according to the present embodiment will be explained with reference to FIG. 1 and FIG. 2A. When a vehicle driver operates the starter switch 16 of the push-button type (at a timing t0, as shown in (a) of FIG. 2A) so as to input the start-up signal to the CPU 12, a command signal for the starter-ON condition (a starter-ON command signal) is outputted from the CPU 12 to each of the hardware latch circuits 13A and 13B (as shown in (f) and (h) of FIG. 2A). Then, an ON-signal (a high level signal) is respectively outputted from each of the hardware latch circuits 13A and 13B to each of the driver circuits 14A and 14B (as shown in (g) and (i) of FIG. 2A). The starter relay 15 is thereby turned on (as shown in (b) of FIG. 2A) to supply electric power to the starter motor 17. As above, an engine cranking operation starts.

In the case that the ON-signals (the high level signals) are outputted from the hardware latch circuits 13A and 13B, and thereby the starter motor 17 is in its ON condition (namely, during the engine is being cranked up), the output signals (the high level signals) of the hardware latch circuits 13A and 13B are not immediately changed to low level signals (as shown in (g) and (i) of FIG. 2A), even when the CPU 12 is reset (at a timing t1) due to a voltage decrease of the battery 10 and thereby the command signal for the starter-ON condition is no longer outputted from the CPU 12 (as shown by one-dot-chain lines between t1 and t3 in (f) and (h) of FIG. 2A). In other words, during a predetermined time period (for example, 400 ms) from the reset of the CPU 12, the output signals of the hardware latch circuits 13A and 13B are kept at a condition of the ON-signal (the high level signals), so that the ON condition of the starter motor 17 is maintained for such predetermined period (for example, 400 ms).

The CPU 12 outputs a command signal for the starter-OFF condition (a starter-OFF command signal) to each of the hardware latch circuits 13A and 13B, when a starter stop condition is satisfied during the operation of the starter motor 17 (for example, at a timing t4). The starter stop condition is regarded as being satisfied when the CPU 12 determines that a rotational speed of the engine exceeds a predetermined value, which is a value for determining completion of engine crank-up, during the starter motor operation, and thereby determines that the engine has been cranked up. The starter stop condition is further regarded as being satisfied when a starter-ON time for the operation of the starter motor 17 exceeds an allowable maximum cranking time, which is defined in view of protecting the battery 10. When the starter-OFF command signals are inputted to the respective hardware latch circuits 13A and 13B (at the timing t4), each of the hardware latch circuits 13A and 13B immediately reverses its output from the ON signal to an OFF signal (a low level signal). The starter relay 15 is thereby turned off to stop the electric power supply to the starter motor 17. As a result, the starter motor 17 is turned off.

According to the present embodiment, the starter stop condition (a starter operation prohibiting condition) may include one of the following determinations, in addition to the above determinations (those are, the determination for completion of cranking up the engine and the determination for the engine cranking operation of the long time period):
a determination of a vehicle speed;
a determination of a shift-lever position;
a determination of fuel leakage;
a determination of an immobilizer;
a determination of fuel pressure;
a determination of a malfunction of the starter motor; and
a determination of checking items in a repair service plant.

The present invention should not be limited to the system having the above determinations. Some of the above starter stop conditions may be deleted, or a further starter stop condition may be added.

According to the present embodiment, in case of the determination of the vehicle speed, the starter stop condition may be regarded as being satisfied when the vehicle speed exceeds a predetermined value.

In case of the determination of the shift-lever position, the starter stop condition may be regarded as being satisfied when the shift-lever is not positioned at a “P” range or an “N” range.

In case of the determination of the fuel leakage, the starter stop condition may be regarded as being satisfied when a fuel leakage is detected.

In case of the determination of the immobilizer, the starter stop condition may be regarded as being satisfied when verification between a key of a vehicle driver and an ECU for the immobilizer is not completed.

In case of the determination of the fuel pressure, the starter stop condition may be regarded as being satisfied when fuel pressure necessary for starting the engine is not achieved.

In case of the determination of the malfunction of the starter motor, the starter stop condition may be regarded as being satisfied when any malfunction of the starter motor 17 is detected by a starter malfunction diagnosing function, which is mounted in the vehicle.

In case of the determination of the checking items in the repair service plant, the starter stop condition may be regarded as being satisfied when a service mode for prohibiting the operation of the starter motor is set during a check-up or repair in the repair service plant.

The determination for the starter stop condition is carried out either by the CPU 12 which controls the operation of the starter motor 17 or by another CPU 20. When the determination for the starter stop condition is carried out by the other CPU 20, a signal for the determination whether the starter stop condition is satisfied or not is transmitted to the CPU 12 via an in-vehicle communication network, such as CAN, LIN and so on.

When the power supply voltage is decreased to become lower than a voltage of a proper operation for the CPU 12 during the starter motor operation and thereby the CPU 12 is reset at the timing t1 (in (c) of FIG. 2A), a predetermined initialization process is carried out (as shown in (d) of FIG. 2A, at timings t2-t3) when the CPU 12 comes back from the reset condition to a normal operation condition (at the timing t2). As shown in (g) of FIG. 2A, during the predetermined time period (for example, 400 ms) from the reset of the CPU 12, the output signals of the hardware latch circuits 13A and 13B are kept at the condition of the ON-signal (the high level signals), so that the ON condition of the starter motor 17 is maintained for the predetermined period (for example, 400 ms).

As shown in (f) and (g) of FIG. 2A, according to a conventional system, the output signals from the CPU are initialized to the starter-OFF command signals in the initialization process (at the timings t2 to t3) at a return of the CPU from the reset condition, in the same manner to an initialization process carried out when the power supply to the CPU is turned on. Namely, the output of the CPU 12 is initialized to the low level signal at the timing t3. Therefore, when the CPU is reset during the starter motor operation, the starter motor is turned off after a hardware latch time (for example, 400 ms), at a timing t3 of (g) of FIG. 2A, due to the initialization process at the return of the CPU from the reset condition. As a result, the engine may not be sufficiently cranked.

According to the present embodiment, an initialization process for the engine crank-up (also referred to as an engine-start-up initialization process) is carried out. At first, when the CPU 12 is reset and returns from the reset condition, the CPU 12 determines whether the starter motor 17 is in an ON condition or in an OFF condition. And then, when the CPU 12 determines that the starter motor 17 is kept in the ON condition by the hardware latch circuits 13A and 13B, not the normal initialization process for the CPU 12 but the engine-start-up initialization process (as shown in (d) of FIG. 2A) for the engine crank-up operation is carried out, so that the starter-ON condition is continued.

The engine-start-up initialization process includes the following processes:

a process for initializing the output signal (that is, the starter-ON or starter-OFF command signal) of the CPU 12 to the starter-ON command signal, which will be outputted to the hardware latch circuits 13A and 13B (as shown in (h) of FIG. 2A, at the timing t3); and

a process for setting a software latch flag to an ON condition (as shown in (e) of FIG. 2A), wherein the software latch flag is a flag for determining the operational condition of the starter motor 17 (that is, the starter-ON or starter-OFF condition) before the generation of the reset of the CPU 12. In other words, it is a process for setting a flag indicating that the starter motor 17 was in the ON condition even before the reset of the CPU 12.

According to the above process, it is avoided that the output signal of the CPU 12 is initialized to the starter-OFF command signal by the initialization process which is carried out at the return of the CPU 12 from the reset condition, and thereby the starter motor 17 is prevented from being turned off. Therefore, it is possible to maintain the starter-ON condition even after the hardware latch time (for example, 400 ms, at the timing t3) from the return of the CPU 12 from the reset condition (as shown in (i) of FIG. 2A). Accordingly, the engine can be surely cranked up.

In other words, the output of the CPU 12 is initialized to the starter-ON command signal at the timing t3. The starter-ON condition is maintained even at the timing t3, which is an end of the holding time (for example, 400 ms) of the hardware latch circuits 13A and 13B from the reset of the CPU 12 (the timing t1). When the CPU 12 confirms thereafter that the engine has been cranked up (at the timing t4), the CPU 12 outputs the starter-OFF command signals to the hardware latch circuits 13A and 13b. When the hardware latch circuits 13A and 13b receive the starter-OFF command signals, the hardware latch circuits 13A and 13b immediately output OFF signals to the driver circuits 14A and 14B, as shown in (i) of FIG. 2A, so that the operation of the starter motor 17 is terminated.

Now, a method for determining the operational condition of the starter motor 17 (that is, the starter-ON or starter-OFF condition) at the return of the CPU 12 from the reset condition (at the timing t2) will be explained. The operational condition of the starter motor 17 can be confirmed by checking electric current flowing through the starter motor 17 or through the starter relay 15. However, according to the present embodiment, the starter-ON or starter-OFF condition is determined by confirming the output side conditions of the hardware latch circuits 13A and 13B. The output side conditions of the hardware latch circuits 13A and 13B can be confirmed by detecting output voltages at output terminals of the hardware latch circuits 13A and 13B, or by detecting voltages at starter driving ports of the ECU 11 (at the output voltages at the driver circuits 14A and 14B).

As one of other alternative methods for determining the operational condition of the starter motor 17, the following method may be also possible. Namely, data of starter-ON or starter-OFF condition before the reset of the CPU 12 may be memorized in a rewritable and non-volatile memory device (for example, back-up RAM), and the data may be read out from the memory device at the return of the CPU 12 from the reset condition in order to confirm the starter-ON or starter-OFF condition. However, according to such a method, data at starting the starter motor in the past might have been memorized in the non-volatile memory, and thereby an erroneous determination for the starter-ON or starter-OFF condition may be done.

According to the present embodiment, however, the starter-ON or starter-OFF condition is determined by confirming the output side conditions of the hardware latch circuits 13A and 13B. Therefore, it is possible to exactly determine the starter-ON or starter-OFF condition at the return of the CPU 12 from the reset condition.

As already explained above, the determination for the starter stop condition is carried out either by the CPU 12, which controls the operation of the starter motor 17, or by the other CPU (ECU) 20. When the determination for the starter stop condition is carried out by the other CPU (ECU) 20, the signal for the determination whether the starter stop condition is satisfied or not is transmitted to the CPU 12 via the in-vehicle communication network, such as CAN, LIN and so on. The CPU 12, which controls the operation of the starter motor 17, outputs the starter-OFF command signals to thereby stop the operation of the starter motor 17 when the starter stop condition is satisfied during the operation of the starter motor 17. On the other hand, the CPU 12 prohibits the operation of the starter motor 17 when the starter stop condition is satisfied during the non-operation of the starter motor 17.

In the case that the power supply voltage is decreased to become lower than the voltage of the proper operation for the CPU 12 during the starter motor operation and thereby the CPU 12 is reset (at the timing t1), there may be a danger that the other CPUs (ECUs) 20 are also reset at the same time. There is a CPU (ECU) among the other CPUs (ECUs), an output of which is initialized to a side indicating that the starter stop condition is satisfied, at a return from its reset condition. Then, such initialized information is transmitted to the CPU 12 for controlling the starter motor 17. In addition, such other CPU 20 transmits a signal for allowing the operation of the starter motor 17 to the CPU 12 (for controlling the starter motor 17) at a timing at which a system check has been completed. As a result, according to the conventional system (or even in the above embodiment explained with reference to FIG. 2A if only the engine-start-up initialization process is carried out), the operation of the starter motor 17 may be terminated at the return of the CPU 12 by or based on the signal, which is transmitted from the other CPU (ECU) 20 to the CPU 12 and which indicates that the starter stop condition is satisfied.

The present embodiment for overcoming the above problem will be further explained with reference to FIG. 2B. In FIG. 2B, timing charts of (a) to (e), (h) and (i) respectively correspond to those of FIG. 2A. Timing charts in (k) and (l) of FIG. 2B show outputs from the CPU 12 and the hardware latch circuits 13A and 13B as comparative examples, when the engine-start-up initialization process is carried out. A timing chart in (j) of FIG. 2B shows a period for the starter stop condition (that is, a period for a signal indicating that the starter stop condition is satisfied). A neglecting time period for the starter stop condition is also indicated.

The CPU 12 may receive from the other CPU (ECU) 20 a signal indicating that the starter stop condition is satisfied during a predetermined period (for example, a period from t5 to t6), after the engine-start-up initialization process has been completed at the timing t3. The period from t5 to t6 is also referred to as a starter-stop-condition satisfying period.

When the CPU 12 receives at the timing t5 from the other CPU (ECU) 20 the signal indicating that the starter stop condition is satisfied, the outputs of the CPU 12 (which have been initialized to the starter-ON command signals (the high level signals) at the timing t3 by the engine-start-up initialization process) are changed to the starter-OFF command signals (the low level signals), as shown in (k) of FIG. 2B. As a result, as shown in (l) of FIG. 2B, the outputs of the hardware latch circuits 13A and 13B are changed to the OFF signals (the low level signals) at a timing t5. The operation of the starter motor 17 is thereby terminated. As above, a sufficient cranking operation for the engine may not be carried out and the engine may not be cranked up.

According to the present embodiment, therefore, as shown in (j) of FIG. 2B, the neglecting time period (for example, the period from the timing t3 to a timing t7) for the starter stop condition is provided. The neglecting time period starts at the timing t3 at the return of the CPU from the reset condition, when the CPU 12 is reset during the operation of the starter motor 17. During such neglecting time period (between the timings t3-t7), the CPU 12 neglects the signal from the other CPU 20, which indicates that the starter stop condition is satisfied. According to such a control process, it becomes possible to prevent the operation of the starter motor 17 from being stopped, even when the signal (indicating that the starter stop condition is satisfied) is inputted from the other CPU (ECU) 20 to the CPU 12. Namely, as shown in (h) of FIG. 2B, the outputs of the CPU 12 can be maintained at the starter-ON command signals (the high level signals) even at the timing t5-t6 so that the operation of the starter motor 17 is continued.

The neglecting time period (the period between the timings t3 and t7), during which the satisfaction (the signals) for the starter stop condition is neglected after the return of the CPU 12, may be set at a predetermined fixed period, or alternatively may be changed depending on at least one of the following parameters;
a voltage of the power supply (the battery voltage);
an ambient temperature;
a temperature of engine lubricating oil;
a number of resets during one cranking operation;
an engine rotational speed; and
a communication establishing time.

For example, when the voltage of the power supply (the battery voltage) becomes lower, the CPU 12 becomes more likely to be reset. Therefore, it may be better to make longer the neglecting time period for the starter stop condition, as the power supply voltage becomes lower. When the ambient temperature or the engine temperature (such as, the temperature of the lubricating oil, the engine cooling water) becomes lower, a period of the engine cranking operation may become longer. Therefore, it may be better to make longer the neglecting time period for the starter stop condition, as the ambient temperature or the engine temperature becomes lower. When the CPU is repeatedly reset during one engine cranking operation, the time for cranking the engine may become longer and thereby a load to the battery may become larger. Therefore, it may be better to restrict the neglecting time period for the starter stop condition, depending on the number of resets of the CPU during one engine cranking operation. When the engine rotational speed becomes higher, the time period to a timing point for stopping the starter motor 17 (to the completion of engine crank-up) may become shorter. Therefore, it may be better to make shorter the neglecting time period for the starter stop condition, as the engine rotational speed becomes higher. When the time for establishing the communication for the in-vehicle communication network becomes longer, a time period during which a signal for allowing the engine cranking operation is transmitted from the other CPU (ECU) 20 to the CPU 12 may become longer. Therefore, it may be better to make longer the neglecting time period for the starter stop condition, as the time for establishing the communication becomes longer.

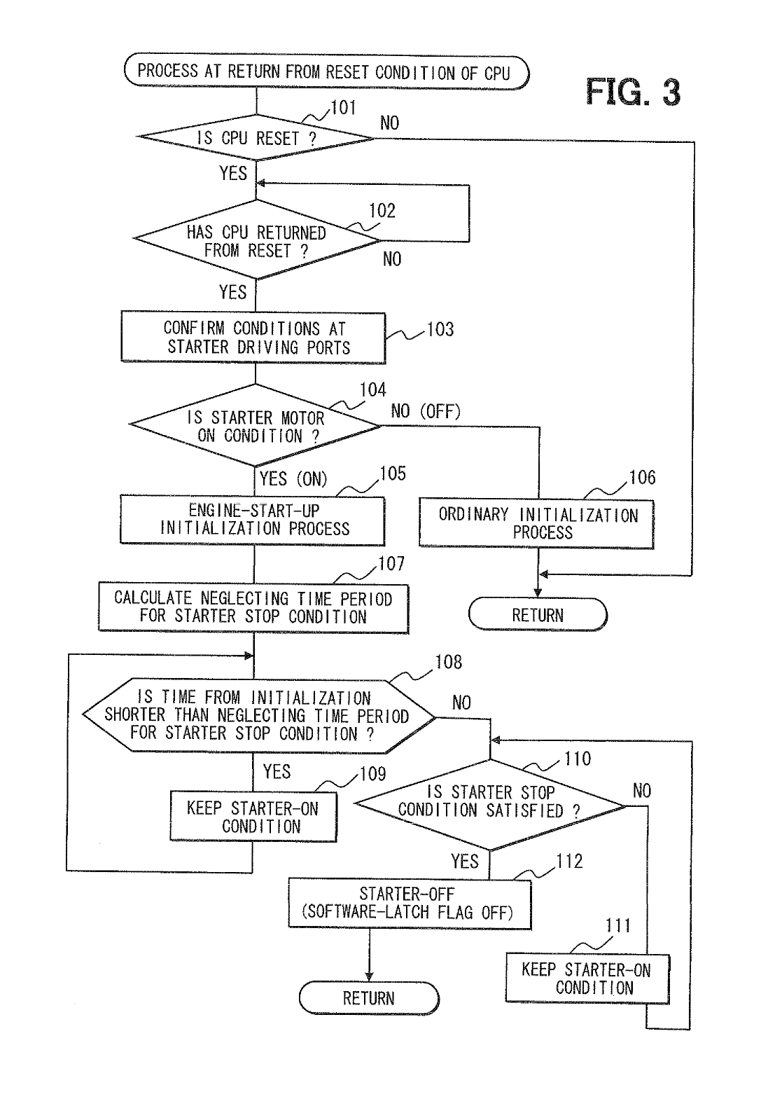

The above explained initialization process is carried out by the CPU 12 in accordance with a flow chart of FIG. 3. The process of FIG. 3 is repeatedly carried out in a predetermined cycle. When the process of FIG. 3 starts, the CPU 12 determines at a step 101 whether the CPU 12 is reset or not. And in case of NO, the process of FIG. 3 ends without carrying out the subsequent steps.

On the other hand, in case of YES at the step 101, namely when the CPU 12 determines at the step 101 that the CPU 12 is reset, the process goes to a step 102 and the process is held until the CPU 12 returns from the reset condition. When the CPU 12 returns from the reset condition, the process goes to a step 103, at which the CPU 12 confirms conditions at the starter driving ports of the ECU 11 (that is, the output terminals of the driver circuits 14A and 14B). Then, the process goes to a step 104, at which the CPU 12 determines whether the starter motor is in the starter-ON condition or in the starter-OFF condition based on the condition at the starter driving ports of the ECU 11. When the CPU 12 determines at the step 104 that the starter motor 17 is in the starter-OFF condition, the process goes to a step 106, at which an ordinary initialization process is carried out. In this initialization process, the command signals from the CPU 12 to the hardware latch circuits 13A and 13B are initialized to the starter-OFF command signal, and also the software latch flag (for determining the operational condition of the starter motor 17 before the generation of the reset of the CPU 12) is initialized to an OFF condition. Then, the process of FIG. 3 ends. According to the above steps, the starter motor 17 is maintained at the starter-OFF condition after the return from the reset of the CPU 12, wherein the starter-OFF condition corresponds to the condition of the starter motor before the reset of the CPU 12.

When the CPU 12 determines at the step 104 that the starter motor 17 is in the starter-ON condition, the process goes to a step 105 at which the engine-start-up initialization process for the engine crank-up operation is carried out. In this initialization process, the command signals from the CPU 12 to the hardware latch circuits 13A and 13B are initialized to the starter-ON command signal, and also the software latch flag (for determining the operational condition of the starter motor 17 before the generation of the reset of the CPU 12) is initialized to the ON condition. As a result of the above initialization process, the starter motor 17 is maintained in the starter-ON condition even after the return of the CPU 12, wherein the starter-ON condition corresponds to the condition of the starter motor before the reset of the CPU 12.

Then, the process goes to a step 107 to calculate the neglecting time period during which the CPU neglects the signals indicating that the starter stop condition is satisfied after the engine-start-up initialization process. As explained above, the CPU calculates the neglecting time period based on at least one of the following parameters;
the voltage of the power supply the battery voltage);
the ambient temperature;
the temperature of engine lubricating oil;
the number of resets during one cranking operation;
the engine rotational speed; and
the communication establishing time.

The process goes to a step 108, at which the CPU compares an elapsed time from the engine-start-up initialization process with the neglecting time period for the starter stop condition. When the elapsed time from the engine-start-up initialization process is shorter than the neglecting time period for the starter stop condition, the process goes to a step 109 at which the CPU 12 neglects the signal from the other CPU (ECU) 20 (indicating that the starter stop condition is satisfied) or neglects any determination made by the CPU 12 (determining that the starter stop condition is satisfied). As a result, the starter-ON condition is maintained until the elapsed time from the engine-start-up initialization process reaches at the neglecting time period for the starter stop condition.

The process goes to a step 110, when the elapsed time from the engine-start-up initialization process has reached at the neglecting time period for the starter stop condition. At the step 110, the CPU 12 determines whether the starter stop condition is satisfied or not. In case of NO at the step 110 (when the starter stop condition is not satisfied), the process goes to a step 111 to keep the starter-ON condition. Thereafter, when the starter stop condition is satisfied, the process goes to a step 112, at which the CPU 12 outputs the starter-OFF command signals to stop the operation of the starter motor 17 and at the same time sets the software latch flag to the OFF condition. The process of FIG. 3 ends with this step.

According to the above explained first embodiment of the present invention, in the case that the CPU 12 is reset during the operation of the starter motor 17 due to the decrease of the battery voltage, the satisfaction of the starter stop condition is neglected during the neglecting time period from the return of the CPU from its reset condition in order that the starter-ON condition is maintained. Therefore, it is possible to prevent the operation of the starter motor from being stopped when the starter stop condition is satisfied at the return of the CPU 12 from the reset condition. As a result, the operation of the starter motor (the engine cranking operation) is continued to start up the engine. As above, it is possible to surely start up the engine with a simple control process, and the problem that the engine may not be cranked up, which may be caused by the reset of the CPU 12, can be solved in a low cost.

### Second Embodiment

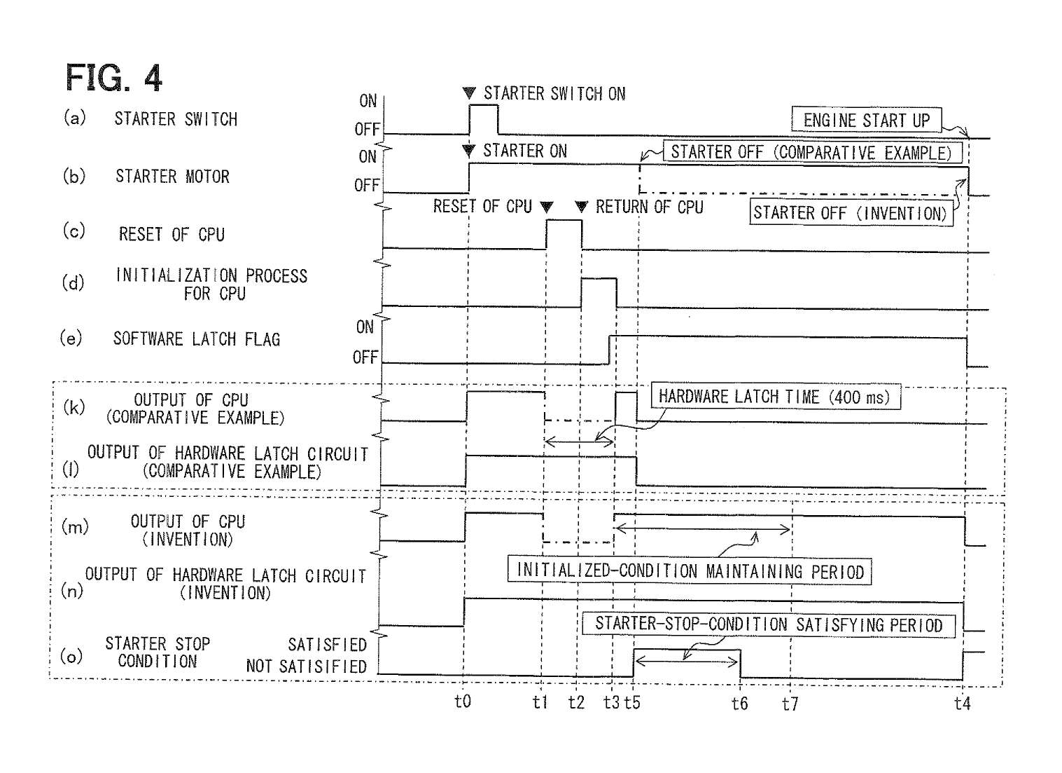

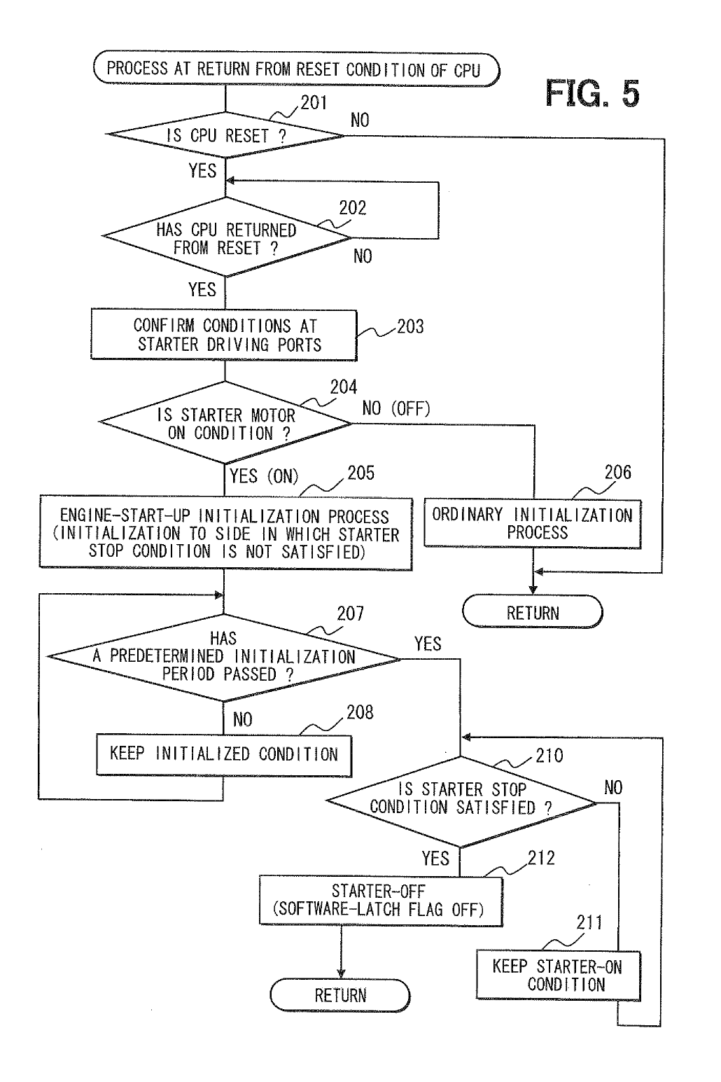

According to the above first embodiment, the satisfaction for the starter stop condition is neglected during the predetermined time period (the neglecting time period) from the return of the CPU from the reset condition, in the case that the CPU 12 is reset during the operation of the starter motor 17. On the other hand, according to a second embodiment of the present invention, as shown in FIGS. 4 and 5, the CPU 12 is initialized to a side, in which the starter stop condition is not satisfied (that is, a side in which the starter operation is allowed) and such initialized condition is maintained for a predetermined time period from the return of the CPU from the reset condition. The starter stop condition in the second embodiment is the same to that of the first embodiment.

In FIG. 4, timing charts in (a) to (e) and (k) to (l) are the same to those of FIG. 2B. Timing charts in (m), (n) and (o) of FIG. 4 show timing charts of the second embodiment. According to the second embodiment, the engine-start-up initialization process is completed at the timing t3, as in the same manner to the first embodiment. Then, the outputs of the CPU 12 are initialized to such a side, in which the starter stop condition is not satisfied (that is, the side in which the starter operation is allowed), as shown in (m) of FIG. 4. Such an initialized condition is maintained for a predetermined period (an initialized-condition maintaining period), for example, until the timing t7.

Therefore, as in the same manner to the first embodiment, the outputs of the CPU 12 are maintained at the initialized condition (initialized to the side in which starter stop condition is not satisfied) during the initialized-condition maintaining period (the timings t3-t7), even if the starter stop condition is satisfied during the period from the timing t5 to the timing t6.

In the second embodiment, the initialized-condition maintaining period (the period from t3 to t7) may be fixed to a constant value, or alternatively may be changed depending on a parameter, such as the power supply voltage, as in the same manner to the first embodiment.

The initialization process of the second embodiment is carried out by the CPU 12 in accordance with a flow chart of FIG. 5. The process of FIG. 5 is repeatedly carried out in a predetermined cycle.

Steps 201 to 204 of the initialization process shown in FIG. 5 are the same to the steps 101 to 104 of FIG. 3. Namely, when the reset of the CPU 12 is generated, the CPU 12 confirms the conditions at the starter driving ports of the ECU 11 when the CPU 12 returns from the reset condition (the steps 201 to 203). Then, at the step 204, the CPU 12 determines whether the starter motor 17 is in the starter-ON or starter-OFF condition based on the condition at the starter driving ports of the ECU 11. When the CPU 12 determines at the step 204 that the starter motor 17 is in the starter-OFF condition, the process goes to a step 206, at which an ordinary initialization process is carried out. In this initialization process, the command signals from the CPU 12 to the hardware latch circuits 13A and 13B are initialized to the starter-OFF command signal, and also the software latch flag (for determining the operational condition of the starter 17 before the generation of the reset of the CPU 12) is initialized to an OFF condition. Then, the process of FIG. 5 ends. According to the above steps, the starter motor 17 is maintained at the starter-OFF condition after the return of the CPU 12 from the reset, wherein the starter-OFF condition corresponds to the condition of the starter motor before the reset of the CPU 12.

When the CPU 12 determines at the step 204 that the starter motor 17 is in the starter-ON condition, the process goes to a step 205 at which the engine-start-up initialization process for the engine crank-up operation is carried out. In this initialization process, the command signals from the CPU 12 to the hardware latch circuits 13A and 13B are initialized to the starter-ON command signal (namely to the side that the starter stop condition is not satisfied, that is the side in which the operation of the starter motor is allowed), and also the software latch flag (for determining the operational condition of the starter motor 17 before the generation of the reset of the CPU 12) is initialized to the ON condition. As a result of the above initialization process, the starter motor 17 is maintained in the starter-ON condition even after the return of the CPU 12, wherein the starter-ON condition corresponds to the condition of the starter motor before the reset of the CPU 12.

At a step 207, the CPU 12 determines whether a predetermined time (the initialized-condition maintaining period: the timings t3 to t7) has passed over after the engine-start-up initialization process (at the timing t3 of FIG. 4). When the elapsed time is shorter than the initialized-condition maintaining period, the process goes to a step 208, so that the initialized condition (initialized to the side in which the starter stop condition is not satisfied) is maintained.

When the elapsed time is over the initialized-condition maintaining period, the process goes to a step 210, at which the CPU 12 determines whether the starter stop condition is satisfied or not. In case of NO at the step 210 (namely, when the starter stop condition is not satisfied), the process goes to a step 211 to keep the starter-ON condition.

When, thereafter, the starter stop condition is satisfied (at the timing t4 in FIG. 4), the process goes to a step 212. The CPU 12 outputs the starter-OFF command signals to stop the operation of the starter motor 17. At the same time, the CPU 12 sets the software latch flag to the OFF condition. The process of FIG. 5 ends with such steps.

According to the above explained second embodiment of the present invention, in the case that the CPU 12 is reset during the operation of the starter motor 17 due to the decrease of the battery voltage, the outputs of the CPU 12 are initialized to the side in which the starter stop condition is not satisfied and such initialized condition is maintained for the predetermined period. Therefore, it is possible to prevent the operation of the starter motor from being stopped when the starter stop condition is satisfied at the return of the CPU 12 from the reset condition. As a result, the operation of the starter motor (the engine cranking operation) is continued to start up the engine. As above, it is possible to surely start up the engine with a simple control process, and the problem that the engine may not be cranked up, which may be caused by the reset of the CPU 12, can be solved in a low cost.

According to the present embodiment, two systems for the hardware latch circuits 13A and 13B and the driver circuits 14A and 14B for driving the starter relay 15 are provided. However, one system or three systems for the hardware latch circuit(s) and the driver circuit(s) may be provided.

The present invention may not be limited to a manually operated engine starting system, but may be also applied to an engine automatic stop-and-start system (an idling-operation stop system).

The present invention may be modified in various ways without departing from the spirit of the invention. For example, a structure of the ECU 11 may be modified in a suitable manner.

What is claimed is:

1. An engine start control system comprising:
a CPU for controlling ON-OFF operation of a starter motor to crank up an engine,
wherein the CPU stops an operation of the starter motor when a starter stop condition is satisfied during the operation of the starter motor, while the CPU prohibits the operation of the starter motor when the starter stop condition is satisfied during non-operation of the starter motor, and
wherein, when the CPU is reset during the operation of the starter motor, the CPU neglects satisfaction of the starter stop condition during a predetermined neglecting period from a return of the CPU.

2. The engine start control system according to the claim 1, wherein
the CPU changes the neglecting period, during which the satisfaction of the starter stop condition is neglected, depending on at least one of the following parameters;
a power supply voltage;
an ambient temperature;
a temperature of engine lubricating oil;
a temperature of engine cooling water;
a number of resets of the CPU during one cranking operation;
an engine rotational speed; and
a communication establishing time for an in-vehicle communication network.

3. The engine start control system according to the claim 1, wherein
the CPU and/or another CPU different from the CPU determines whether the starter stop condition is satisfied based on at least one of the following determinations;
a determination for an engine cranking operation of a long time period;
a determination of a vehicle speed;
a determination whether the engine cranking operation has been completed;
a determination of a shift-lever position;
a determination of fuel leakage;
a determination of an immobilizer;
a determination of fuel pressure; and
a determination of a malfunction of the starter motor.

4. An engine start control system comprising:
a CPU for controlling ON-OFF operation of a starter motor to crank up an engine,
wherein the CPU stops an operation of the starter motor when a starter stop condition is satisfied during the operation of the starter motor, while the CPU prohibits the operation of the starter motor when the starter stop condition is satisfied during non-operation of the starter motor, and
wherein, when the CPU is reset during the operation of the starter motor, the CPU is initialized to a side in which the starter stop condition is not satisfied at a return of the CPU, and such an initialized condition is maintained for a predetermined period from the return of the CPU.

5. An engine start control system comprising:
a CPU for controlling ON-OFF operation of a starter motor to crank up an engine; and
a holding circuit for keeping a starter-ON condition for a predetermined period, when the CPU is reset during an operation of the starter motor,
wherein, when the CPU returns from its reset condition, the CPU confirms an operational condition of the starter motor at the reset of the CPU,
wherein, when the CPU confirms that the operational condition of the starter motor at the reset of the CPU was in the starter-ON condition, the CPU carries out an engine-start-up initialization process for an engine crank-up operation according to which the operational condition of the starter motor is maintained in the starter-ON condition, and
wherein the CPU neglects satisfaction of a starter stop condition during a predetermined neglecting period from a return of the CPU.

6. The engine start control system according to the claim 5, wherein
the CPU receives from another CPU a signal indicating that the starter stop condition is satisfied.
